(19) United States
(12) Patent Application Publication
(10) Pub. No.: US 2003/0096548 A1
(43) Pub. Date: May 22, 2003

(54) Regularly structured nonwoven fabrics, method for their manufacture, and their use

(76) Inventors: Dieter Groitzsch, Hirschberg (DE); Oliver Staudenmayer, Weinheim (DE)

Correspondence Address: KENYON & KENYON, ONE BROADWAY, NEW YORK, NY, 10004, US

(21) Appl. No.: 10/196,848

(22) Filed: Jul. 16, 2002

(30) Foreign Application Priority Data
Jul. 16, 2001 (DE) 101 33 773.6

(51) Int. Cl. B32B 1/00; B32B 5/26; B29C 61/02

(52) U.S. Cl. 442/268; 428/141; 442/381; 442/394; 442/319; 264/230

(57) ABSTRACT

A three-dimensionally structured fibrous fabric having elevations and depressions occurring regularly in alternation in relation to the surface plane, includes at least one nonwoven fabric layer and a shrunk fabric bonded thereto. In this context, the nonwoven fabric layer and the shrunk fabric were bonded by heat sealing performed at least perpendicular to the direction of the greatest shrinkage of the shrunk fabric in the form of lines. The fabric may be used as filter materials, in hygiene articles or as the mechanically sticking part of Velcro fasteners.

### CROSS-REFERENCE TO RELATED APPLICATIONS

The present application claims priority to German Application No. 101 33 773.6, filed in the Federal Republic of Germany on Jul. 16, 2001, which is expressly incorporated herein in its entirety by reference thereto.

### FIELD OF THE INVENTION

The present invention relates to nonwoven fabrics having a regular surface pattern, as well as their manufacture and use.

### BACKGROUND INFORMATION

European Published Patent Application No. 0 814 189 describes a nonwoven fabric made of at least one unidirectionally stretched spunbond and a short-fiber nonwoven mechanically joined to it. The laminate is characterized by high volume and a good hand.

Three-dimensionally structured fibrous fabrics are conventional. German Published Patent Application No. 199 00 424 describes three-dimensionally structured combinations of continuous-fiber layers and staple-fiber layers that are heat-sealed together in the form of a regular pattern. The three-dimensional structure is developed by using fiber layers having different shrinkage capacity. A three-dimensional structure is impressed on the staple-fiber layer by triggering the shrinkage. However, in so doing, it has turned out that the three-dimensional structure resulting is irregular, since the sequence of elevations and depressions is arranged according to a rather random pattern.

Examples for such laminates are fibrous fabrics made of at least one or two nonwoven fabrics and extruded, biaxially stretched nets made, for example, of polypropylene (referred to as “PP” hereinafter). After lamination, they develop raised structures in the third dimension due to shrinkage. Because, inter alia, of the shrinkage in both directions, i.e., in the lengthwise and crosswise orientation of the monofilaments of the stretched PP net, these raised areas are relatively irregular and not particularly attractive visually. The cohesion of the two nonwoven-fabric layers is usually effected through the net by heat-sealing in a calender with pressure and heat at certain points or in a pattern.

It is an object of the present invention to provide three-dimensionally structured fibrous fabrics having a regular three-dimensional pattern.

It is another object of the present invention to provide a method by which a uniform structure may be produced, e.g., to predetermine the structure of the three-dimensional elevations and depressions by specific measures according to the present invention, and to prevent the randomness and the irregularities of the structure associated with it.

### SUMMARY

The present invention relates to a three-dimensionally structured fibrous fabric having elevations and depressions occurring regularly in alternation with respect to the surface plane, including at least one nonwoven-fabric layer and a shrunk fabric bonded thereto, the nonwoven fabric layer and the shrunk fabric being bonded by heat sealing, and the heat sealing being performed at least perpendicularly to the direction of the greatest shrinkage of the shrunk fabric in the form of regularly arranged lines, e.g., in the form of regularly arranged and uninterrupted lines.

The laminate of the present invention has at least one layer of nonwoven fabric and at least one layer of another fabric which is developed so that it is inclined toward shrinkage, i.e., reduction in its area under the effect of moist and/or dry heat.

The nonwoven fabrics used according to the present invention, which do not shrink or shrink only slightly under manufacturing conditions, may be made of any fiber types with greatly differing titer ranges, for example, titers from 0.5 to 5 dtex. In addition to homofil fibers, heterofil fibers or blends of greatly differing fiber types may also be used. Besides spunbonded nonwovens, e.g., staple-fiber nonwoven fabrics, e.g., unbonded staple-fiber nonwoven fabrics are used.

In one example embodiment, the three-dimensionally structured fibrous fabric according to the present invention contains three layers. The two nonwoven fabrics covering the shrunk fabric in a three-dimensional manner are staple-fiber nonwoven fabrics, and the covering nonwoven fabrics may exhibit the same or different fiber orientations and/or the same or different fiber structure.

Typically, the nonwoven fabrics or their unbonded precursors (fiber fleeces) used may have masses per unit area of 6 to 70 g/m².

In one example embodiment, the three-dimensionally structured fibrous fabric of the present invention includes three layers and has masses per unit area of 15 to 150 g/m².

Nonwoven fabrics having low masses per unit area of 6 to 40 g/m² may be used. Particularly light-weight, and at the same time highly absorbent laminates may be produced from these nonwoven fabrics.

The heat seal between the fibrous web and/or the nonwoven fabric and the shrunk or shrinkable fabric of the laminate according to the invention may be effected by heat and pressure in the calender nip and/or by ultrasound.

In this context, the shrinkage may take place in only one preferential direction, but also in both or more than two directions. The shrinkage amounts in the case of several directions, such as in both directions, i.e., in the machine running direction and at a ninety degree angle to the machine running direction, may be the same or completely different.

To establish the bonding pattern for fixing the nonwoven fabric, which is incapable or only slightly capable of shrinkage under process conditions, in place on the shrinkable fabric, their relationship in the lengthwise to crosswise direction may be approximately reproduced, e.g., in the same relationship. If, for example, the shrinkable fabric shrinks exclusively in the lengthwise direction, and thus exhibits no crosswise shrinkage at all, then the line pattern for heat sealing the nonwoven fabric and shrinkable fabric may be selected perpendicular to the lengthwise direction. Thus, for example, as an engraved calender roller, one may be selected which has elevations that are aligned 100% in the crosswise direction, i.e., it may have continuous lines for the heat sealing.

The spacing of these lines and the linear shrinkage amount are responsible for the shaping of the elevations and depressions. That is, the form of the parts of the fibrous fabric projecting from the plane is precisely established by the progression of the lines of the heat-sealing pattern.

The shrinking or shrunk fabric may be of any nature. In this context, it may be a shrinkable fibrous fabric, e.g., a woven fabric, knit fabric, net, interlaid scrim, parallel-running monofilaments or staple-fiber or multifilament yarns, or a nonwoven fabric, or it may be a shrinkable film. The shrinkable fibrous fabric may be made of stretched threads or yarns that are in linear alignment and oriented parallel to one another. The stretched or drawn threads or monofilaments may be made or crossed by other stretched or unstretched or less stretched threads/monofilaments or yarns aligned at an angle with respect to the first. The crossing fibers, threads or monofilaments may be bonded to the others by self-bonding, for example, by mechanical bonding or by heat sealing at the intersections. However, the bonding may also be effected using binding agents such as aqueous dispersions.

The three-dimensionally structured fibrous fabric, built up according to the present invention and bonded to form a laminate, may be made of a shrunk fabric and at least one nonwoven fabric that is not shrunk or has shrunk less under process conditions. However, the shrunk fabric may also be covered with a nonwoven fabric on both sides, either symmetrically or asymmetrically, i.e., the weights of the two nonwoven fabric layers may be different or the same. Both nonwoven fabric layers, if they tend to shrink at all, may have the same or different amounts of shrinkage. However, at least one of the two nonwoven fabric layers may be shrunk less than the shrunk fabric positioned in the middle.

The shrinkable or shrunk fabric of the laminate may be made of a uniaxially or biaxially drawn film or sheeting. The film may have been produced according to conventional manufacturing methods, for example, according to the blowing method, i.e., may have been drawn in tubular form. However, it may also have been formed by extrusion through a sheeting die or a broad-slit die, and have been lengthened in the machine running direction by mechanical stretching, or have been stretched crosswise to the machine running direction by a stretching frame or by passing through an intermeshing pair of rollers with furrows in the machine running direction.

The usual stretching ratio of the film is up to 5:1 in one or both stretching directions. The stretching ratio should be understood to mean the length ratio of the film after compared to before the stretching.

The extrudate of the film may be provided with generally conventional fillers or structure-forming agents, for example, with inorganic particles such as chalk, talc, kaolin, etc. In this manner, by stretching in a generally conventional manner, a microporous structure may be produced having, e.g., improved breathing properties.

However, the film may also have been perforated using generally conventional methods prior to stretching, so that the perforations expand to become larger perforations after the stretching.

The film may also have been slit prior to stretching, so that particularly by stretching at a 90° angle to the length extension of the slits, they are expanded to become perforations.

The film may have been weakened in a pattern prior to stretching, so that the weakened spots are expanded to become perforations during stretching. The pattern-like weakening of the film may be performed by passing through a calender roller, i.e., by heat and pressure, or by ultrasound treatment.

Regardless of whether it is perforated, weakened in a pattern or slit, the film may be made of a single layer or may be built up from a plurality of layers, i.e., at least two, by coextrusion. One of the two or both outer layers of the coextruded film may be made of thermoplastics with a lower melting point than the other and/or the middle layer. The fibers of the nonwoven fabric layers surrounding the shrink film may be bonded exclusively to the layer(s) of the coextruded film having the lower melting point, and not to the middle layer.

The shrinkable or shrunk fabric of the laminate may be made of a loose fibrous web of 100% shrinking, i.e., highly stretched fibers, that has been formed according to conventional web-laying techniques. The fibers may have been laid down isotropically or in a preferential direction, i.e. anisotropically. Prior to lamination, the fibrous web may be pre-bonded with at least one non-shrinking fibrous nonwoven fabric layer using conventional methods, the bonding conditions being controlled so that the shrinking capability is not influenced or is only influenced insignificantly. The fleece made up of shrinking fibers may be made of the same or different titers of the same fiber. The titer of these fibers usually is in the range from approximately 0.5 dtex to approximately 50 dtex, e.g., however, in the range between 0.8 and 20 dtex. The fibers making up the shrinkable or shrunk nonwoven fabric or fleece may be made up of widely varying fibers, for example, of homofil fibers, but also of 100% bicomponent fibers or a blend of bicomponent fibers and homofil fibers, with the restriction that the polymer of the bicomponent fibers which has the higher melting point is identical with that of the homofil fibers, such as, for example, the fiber blend PP homofil with PP/PE side-by-side or core/sheath bicomponent fiber (PE=polyethylene). In the latter case, the sheath component is made of PE and functions as a binding substance for fixing one or two non-shrinking fibrous fabrics in place on one or both sides of the shrink fiber layer.

The shrinking or shrunk fleece or nonwoven fabric layer may have been perforated using conventional methods, or may have a net-like structure.

The methods of perforation or structure-formation may be based on the principle of pushing the fibers aside in a pattern. Such methods, which do not destroy the material, are described in European Published Patent Application Nos. 0 919 212 and 0 789 793.

The perforation methods described above for the film may also be used.

Uniaxially or biaxially stretched, extruded plastic nets may also be used as the shrinking or shrunk layer of a composite structure. The degree of stretching in both directions may be the same or different.

At least one preferential direction may be highly stretched. A high degree of stretching or drawing should be understood to be a stretching ratio of at least 3:1.

The thickness of the fibers is usually 150 to 2000 μm. Extruded plastic nets should be understood to mean fabrics having a grid structure that is formed in that first monofilament sets, arranged in parallel, cross with second monofilament sets, likewise arranged in parallel, at a certain constant angle, and are inherently bonded together at the intersections. In the case of plastic nets, the two monofilament sets are normally made of the same polymer. However, the thickness and the degree of stretching of the two filament sets may be different.

Interlaid scrims may also be used as the shrinkable or shrunk fabric. They differ from plastic nets or grids in that the intersecting filament sets are not bonded together at their intersections by inherent bonding, but rather by application of a binder such as aqueous polymer dispersions. In this case, the two parallel-oriented monofilament sets may be made of different polymers. Interlaid scrims may only be suitable for use in the present invention if at least one of the two filament sets is present in stretched form. In the case of interlaid scrims, both stretched monofilament threads and homofilaments may be used. In principle, the angle of the intersecting filament sets may be any desired angle. However, the angle of 90° may be provided for practical reasons. The filament sets of the interlaid scrim or plastic net may be aligned in parallel, in the machine running direction, and the second filament sets are aligned crosswise, i.e., at a 90° angle to the machine running direction. The distance between the first filaments aligned in parallel in the machine running direction may be in the range between approximately 0.5 and approximately 20 mm, e.g., between 2 and 10 mm, and that of the second parallel-aligned filament sets is between 3 and 200 mm. The first filament sets may contribute at more than 50 up to 100%, e.g., at 70 to 100%, and, e.g., 100% of the total area shrinkage. In the latter case, precisely formed undulations or corrugations may be obtained.

The second filament sets-may contribute to the total area shrinkage at 0 to 50%, e.g., 0 to 30%, and e.g., 0%.

In addition to the shrinking or shrunk fabrics already described, woven fabrics and knit fabrics may also be used, with the proviso that at least one of the two preferential directions, i.e., in a woven fabric, the warp or the weft, is made of shrinking or shrunk fibers.

The nonwoven fabric used for shrinkage may have been subjected to a lengthening process before being laminated to form a composite. The nonwoven fabric may be lengthened by mechanical forces in the machine running direction and—provided it is made of fully stretched fibers—is shortened accordingly in the crosswise direction, that is to say, it experiences a loss in width.

Such so-called neck-in-stretch processes result in a clear reorientation of the fibers in the nonwoven fabric in the direction of the stretching that was performed. Such a reorientation may be brought about more easily, in that bonds within the nonwoven fabric are broken or greatly loosened during the stretching process by elevation of temperature, and the reorientation of the fibers is preserved by cooling to room temperature. Such reorientation of the fibers may be provided if previously an isotropic nonwoven fabric or one with only a slight preferential alignment of the fibers was present, i.e., if the shrinkage is desired only in one direction, and a clear undulation in the nonwoven fabric is desired.

The present invention also relates to a method for producing the three-dimensionally structured fibrous fabric further defined above, including the following measures:

a) combining at least one fibrous web and/or one nonwoven fabric with a shrinkable fabric,

b) heat-sealing the fibrous web and/or the nonwoven fabric to the shrinkable fabric in the form of a line pattern, e.g., by heat and calender pressure and/or by ultrasound, the line pattern extending at least perpendicular to the direction of the greatest shrinkage of the shrinkable fabric,

c) heating the resulting laminate to such a temperature that shrinkage of the shrinkable fabric is triggered, and elevations and depressions occurring in an alternating and regular manner in relation to the surface plane are formed.

The heat sealing of the fibrous web and/or nonwoven fabric and the shrinkable fabric may be performed in any manner, for example, by calendering with an embossing calender whose one roller has a regular line pattern, or by heat sealing using ultrasound or infrared radiation, which in each case act on the nonwoven fabric in a predetermined pattern.

The laminate of the present invention is characterized by a great thickness in relation to its low mass per unit area. The elevations and depressions, occurring in alternation, create space for the absorption of low- to high-viscosity fluids, liquid multiphase systems such as suspensions, dispersions and emulsions or other disperse systems also containing solid matter, as well as solid particles and dust from the air or gases. These fluids or solid particles may either completely or partially fill the spaces between the alternating elevations and depressions, or else may cover only the surface of the laminate according to the present invention with a coating.

The laminate of the present invention may be used, e.g., in the fields of filters for liquid-, dust- and/or particle filtration, as a high-volume absorption and distribution layer in hygiene articles, e.g., in diapers or for feminine hygiene articles, as well as as a mechanically sticking part for Velcro fasteners. These uses are also a subject matter of the present invention.

### BRIEF DESCRIPTION OF THE DRAWINGS

FIG. 1 illustrates a shape of the correlations (hills/undulations).

FIGS. 2a, 2b and 2c illustrate details illustrated in FIG. 1.

FIGS. 3, 4a and 4b illustrate the surface of a calender roller.

FIGS. 5a and 5b illustrate the case of shrinkage of in each case 50% in the machine running direction and crosswise to the machine running direction.

FIGS. 6a and 6b illustrate a laminate of the present invention having linear shrinkage crosswise to the machine running direction.

FIGS. 7a and 7b illustrate a laminate of the present invention having linear shrinkage in the machine running direction.

FIGS. 8a and 8b illustrate a laminate of the present invention having linear shrinkage crosswise to and in the machine running direction.

FIG. 9 is a perspective view of the laminate illustrated in FIG. 8b.

### DETAILED DESCRIPTION

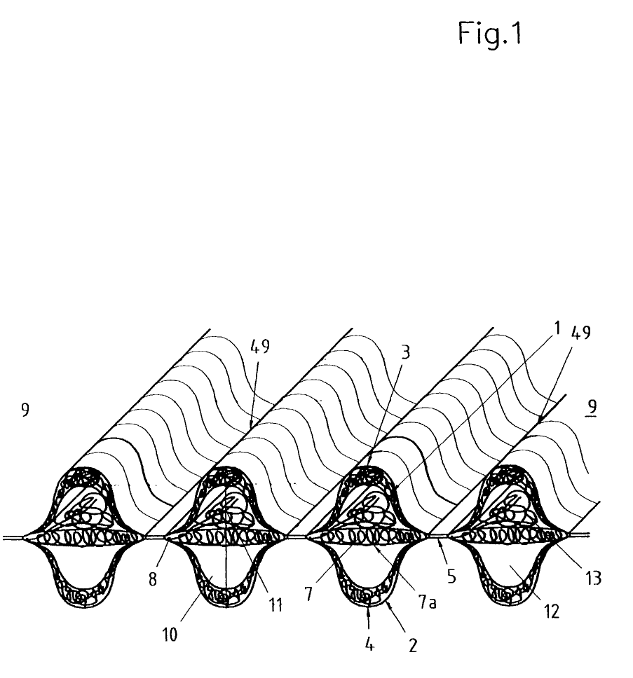

One of the numerous variants of the fibrous fabric according to the present invention is illustrated schematically in FIG. 1. In this case, the laminate is made of a total of three nonwoven fabric layers.

(1) and (2) are each unshrunk nonwoven fabric layers which have been welded onto the fibrous web of a third nonwoven fabric (7), positioned in the middle of the laminate, by pressure and temperature or by ultrasound welding in the form of uninterrupted lines prior to the shrinkage treatment. The three nonwoven fabric layers are intimately bonded to one another at bar-like, i.e., linear heat-sealing locations (5) aligned parallel to one another. In the laminate illustrated in FIG. 1, both the fiber blends and the masses per unit area of both nonwoven fabric layers (1) and (2) are identical, so that after shrinkage of nonwoven fabric layer (7), a double wave precisely mirror-inverted in cross-section is formed, having the same wave height (10) and (11). Wave height should be understood to mean the maximum distance of the wave from the center of the laminate. In the area of peaks (3) and (4) of the mirror-inverted undulations, the fibers of nonwoven fabric layers (1) and (2) are compacted the least. The compacting increases more and more from peaks (3) and (4), respectively, to heat-sealing location (5), and reaches its absolute maximum there. Shrunk nonwoven fabric layer (7) is bonded most weakly in middle (7a) between bar-like heat-sealing locations (5), and is bonded most strongly within heat-sealing locations (5).

Nonwoven fabric layers (1) and (2) may also be composed differently and have different masses per unit area. The shrinkage in the case of FIG. 1 occurred exclusively in the direction along line 9-9, this direction being identical with the machine running direction (lengthwise direction). Due to the wave-shaped raised areas of nonwoven fabric layers (1) and (2), cavities (12) and (13) are formed disposed in a mirror image.

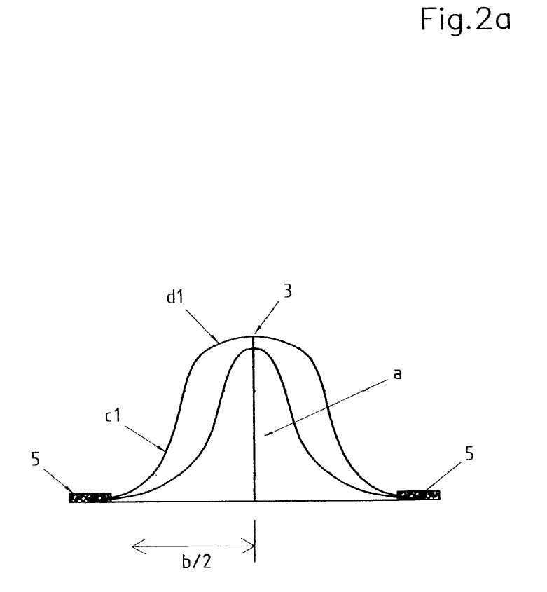

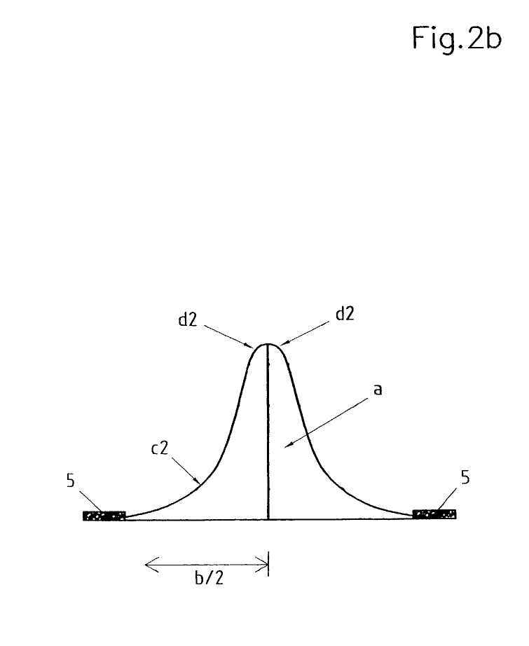

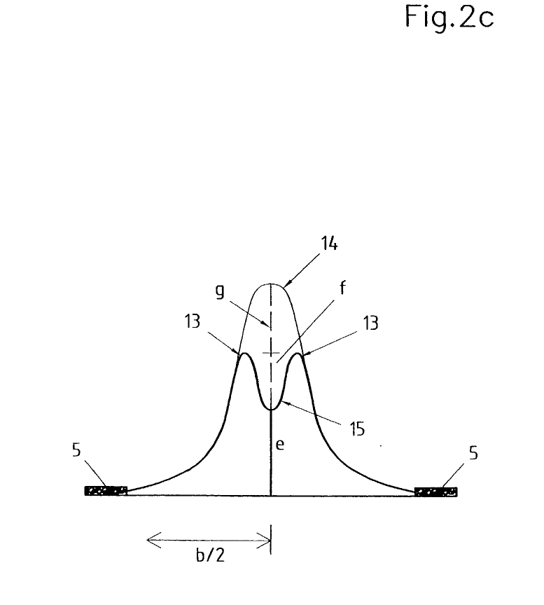

FIGS. 2a, 2b and 2c illustrate the upper half of the mirror-inverted undulation in cross-section, i.e., along line 9-9. As illustrated in FIG. 2a, the undulation extends from one heat-sealing location (5) via peak (3) to second heat-sealing location (5). Turning point (c1) of the undulation and second turning point (d1), and thus the “bulginess” of the undulation are strongly dependent on the draping properties, i.e., deformability of nonwoven fabric (1) (and (2)). FIG. 2a illustrates a nonwoven fabric having greater stiffness (less drapeability) than that illustrated in FIG. 2b. In the case of very light nonwoven fabric weights with very weak bonding within the nonwoven fabric layer, or only spot-bonding, it may occur that peak (14) of the undulation collapses within itself because of insufficient stiffness, as illustrated in FIG. 2c. Two new peaks (13) are thereby formed which, in the ideal case, are disposed symmetrically with respect to center axis g and have the same shape.

The ratio a/0.5b of height a of the undulation to half the distance b/2 between two adjacent heat-sealing lines (5), and the drapeability of both nonwoven fabric layers (1) and (2) essentially determine the shape of the undulation. Height a in relation to b/2 is determined by the ratio of the distance between heat-sealing regions (5) before and after shrinkage. The greater this ratio (b before) to (b after) is, the greater the ratio a/0.5(b after) becomes. The proportion of area in the laminate that is covered by undulations or hills in relation to the total area after the shrinkage depends equally on the proportion of area of the areas not bonded to (7) prior to shrinkage, i.e., after heat sealing to form a laminate, and the degree of area reduction due to shrinkage. The number of undulations or hills per m² is determined by the amount of area shrinkage. The size of the undulations, i.e., distance b after shrinkage, i.e., of the hills, is determined by the size of the areas not bonded by heat-sealing regions (5) and the ratio of the areas before and after shrinkage.

The form of the elevations or raised areas in the shrunk laminate, i.e., their deformation after shrinkage, depends on the form of the areas not bonded to middle layer (7) at welding or bonding locations (5), the total area shrinkage, and the ratio of shrinkage in the machine running direction and crosswise to the machine running direction. In the case of monofilaments or multifilaments bound into the laminate and highly stretched in parallel in the machine running direction (i.e., generally in a preferential direction), a so-called linear shrinkage occurs, which should be understood to mean shrinkage exclusively in this preferential direction.

In the example embodiments of the present invention, the fibers or portions of the fiber blend of the non-shrinking nonwoven fabric layers of the 3-layer composite may be coordinated more or less with the shrinking center layer. The softness or stiffness of these 3D (=three-dimensionally) structured outer layers may be modified within wide limits by the selection of the fibers used. The form of these 3D nonwoven fabric layers is largely a function of the properties required, i.e., the applications demanding them.

It may be of importance for the example embodiment of the two outer layers of the laminate, deformed to form 3D structures, and for their structural integrity, whether the shrinkage-triggering middle layer has a porous or a dense, i.e., impermeable structure, that is, whether it is made of fibers, nets, interlaid scrims or impermeable films.

When using films, the separation force between the 3D nonwoven fabric layers and the film is determined exclusively by the quality of the bond between fibers and film at the interface to the film. The film acts as a separating layer for the upper and lower 3D nonwoven fabric layers. To achieve sufficient separation forces/lamination forces between the film and the 3D nonwoven fabric layer, the film and the fibers (at least a portion of a fiber blend) may be adhesion-compatible with one another. This may be achieved in that the film and the fibers, or one fiber component of bicomponent fibers, or fiber components of the fiber blend, are made of chemically similar polymers or polymers with the same structure. If, for example, a PP film (PPO film) that has been biaxially stretched using the blowing method is used as the shrink-triggering film, then for the purpose of good adhesion, at least high percentage portions (of at least 20-30% by weight) of the nonwoven fabric layer deformed to form the 3D structure may be made of polyolefin or polyolefin copolymer homofil fibers, or when using bicomponent fibers, the binding component with the lower melting point may be made of polyolefin.

Examples for such fibers that adhere well to PP film are fibers made of PP, PP-copolymer, PE or PE-copolymer, or bicomponent fibers whose core is made, for example, of polyester, and whose sheath is made of PP, PE or copolymers thereof. The fiber polymer functioning as the adhesive component may have been laced with a tackifier=tackiness agent or plasticizer. To achieve a destruction-free or non-damaging effect when heat-sealing the fibrous web(s) to the film by ultrasound or by heat and pressure, the melting point or thermoplastic softening point of the fiber components having a lower melting point may not be higher than that of the stretched film, or may be at least 5 to 10° C. below that of the film.

Another possibility for protecting the film, i.e., the core of the film, from mechanical destruction or weakening is to use a so-called bilaterally or unilaterally co-extruded, stretched film. Within the framework of this description, this should be understood to mean a two-layer to three-layer film whose core is made of a polymer which is more thermally stable than the polymer which forms the one or two outer layers. A three-layer, stretched film with PPO as the core and two outer layers (generally lighter in weight) made of polyethylene, polyolefin copolymers or EVA (copolymer of ethylene and vinyl acetate) may be mentioned as examples of this.

If nets or interlaid scrims stretched according to the present invention are used as the shrink-triggering layer, then the coordination of the polymer composition of the fibers of the nonwoven fabric, deformed to produce the 3D structure, with the shrinking middle layer for the purpose of nonwoven fabric/net adhesion plays a much lesser role or no role at all. The area coverage by the oriented monofilaments in the lengthwise and crosswise direction in an interlaid scrim/net is negligibly small in relation to the total area. Bonding of the two nonwoven fabric layers above and below the interlaid scrim/net essentially occurs through the open areas not covered by filaments. Adhesion of the fibers to the monofilaments of the net/interlaid scrim is almost insignificant. For sufficient laminate adhesion, the upper 3D nonwoven fabric layer may be made up of identical or chemically similar, i.e., compatible binding fibers, as the fibers forming the interlaid scrim/net. Their proportion in both nonwoven fabric layers may be the same or different.

Like the film, the stretched net may be co-extruded, the use of a co-extruded net making no significant contribution to the laminate adhesion for the reasons indicated above.

The production of the two-layer or three-layer laminate and its shrinkage to form laminates with a 3D structure may be performed in separate steps. Moreover, it is possible to select the binding fibers that result in the laminate adhesion for improving structural integrity, such that their softening range, i.e., hot-melt adhesion range, is approximately at least 10° C., e.g., at least 15° C. below that of the shrinkage-triggering layer. The production of 3D structures by shrinkage according to the present invention may be provided for the process control, uniformity of the area shrinkage, and the formation of the quality of the 3D structure by two separate steps. While in the case of a lamination by heat and pressure, it is possible in principle to combine the two process steps in the calender nip or by looping around a heated calender roller for the purpose of increasing the dwell time of the goods, this is not actually recommended, because it is associated with a drastic reduction in the production speed.

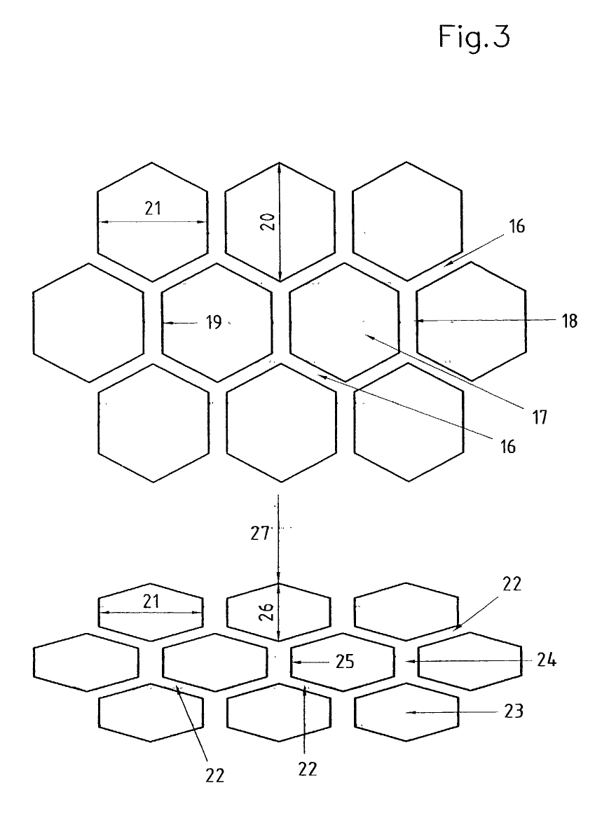

FIG. 3a is a top view of the surface of a calender roller having depressions in the form of an equilateral hexagon. In principle, the equilateral hexagon is already precisely defined by its area (17) and edge length (19). To further define the hexagon, FIG. 3a also indicates length (20) from the top tip to the bottom tip, i.e., in machine running direction (27), and the width of the hexagon crosswise to the machine running direction. The two shortest distances (16) and (18) between the equilateral hexagons are identical and reproduce the frame of the hexagon, and thereby the uninterrupted heat-sealing lines, i.e., the heat-sealing pattern with a honeycomb structure in the non-shrunken laminate that has been heat-sealed using heat and pressure or ultrasound.

FIG. 3b illustrates the case of a laminate shrunk exclusively in machine running direction (27), having a linear shrinkage of 50%. Such a shrinkage occurs, for example, if an extruded net that was stretched only in the machine running direction is used as the shrinking fabric.

Due to this 50% shrinkage in only one preferential direction, (for example, the machine running direction) distance (20) is reduced by half to distance (26) in the laminate, and edge length (19) is reduced by half to edge length (25), while distance (21) remains unchanged before and after the shrinkage. Area (17) of the equilateral hexagon is reduced to area (23), and the equilateral hexagon before shrinkage becomes a non-equilateral hexagon that has been compressed by 50% in the machine running direction. As a result, equal distances (16) and (18) now become unequal distances (22) and (24) after shrinkage, where (24)>(22).

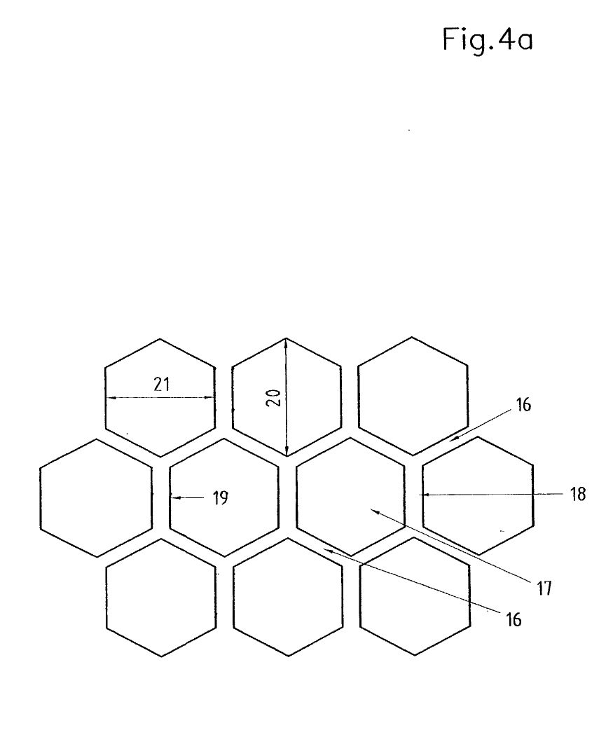

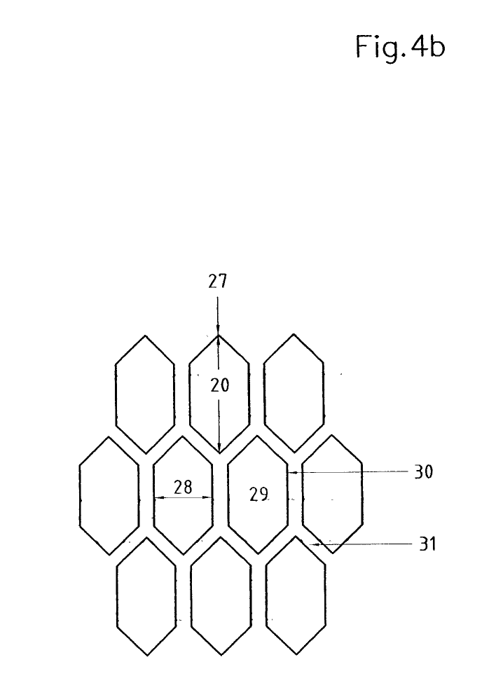

FIG. 4a illustrates the same surface of a calender roller as that illustrated in FIG. 3a.

FIG. 4b illustrates the case of a laminate shrunk exclusively crosswise to machine running direction (27), having a linear shrinkage of 50%. Such a shrinkage occurs, for example, if an extruded net that was stretched only transversely to the machine running direction is used as the shrinking fabric.

Due to this 50% shrinkage in only one preferential direction, distance (21) is reduced by half to distance (28) in the laminate, while distance (20) remains unchanged before and after shrinkage. Area (17) of the equilateral hexagon is reduced to area (29), and the equilateral hexagon before shrinkage becomes a non-equilateral hexagon that has been compressed by 50% transversely to the machine running direction. As a result, equal distances (16) and (18) now become unequal distances (30) and (31) after shrinkage, where (31)>(30).

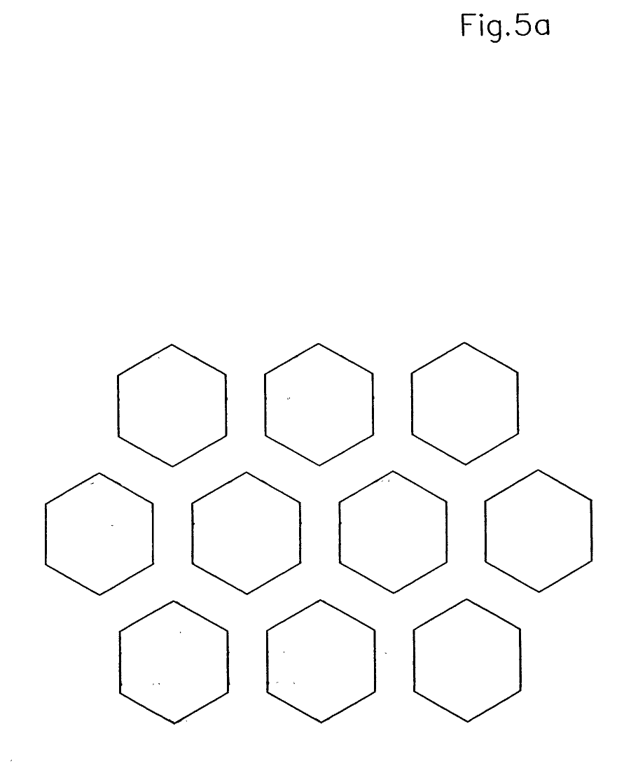

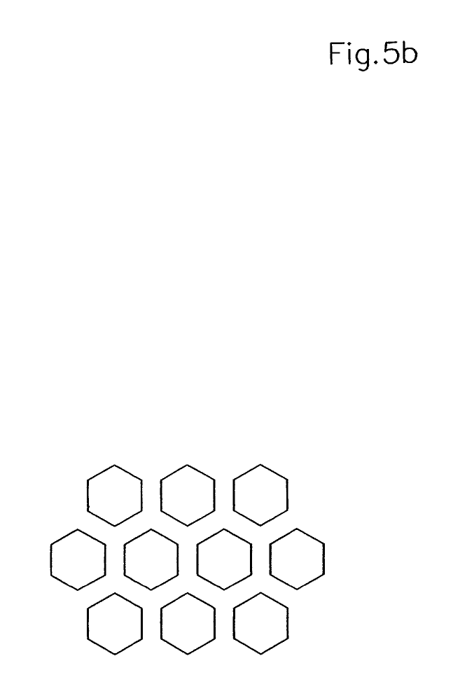

FIGS. 5a and 5b illustrate the case of a shrinkage in each case of 50% in the machine running direction and crosswise to the machine running direction. The total shrinkage is 75%. In this case, the equilateral hexagons become smaller in size correspondingly, and remain equilateral. The shortest distances between the lateral sides decrease by 50%.

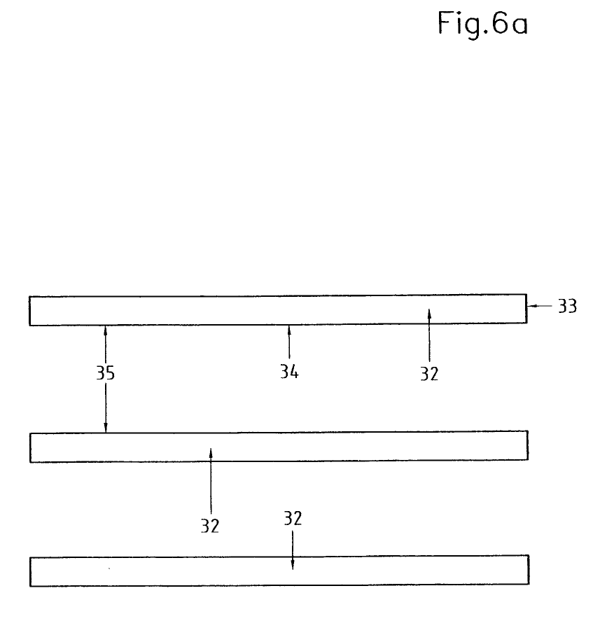

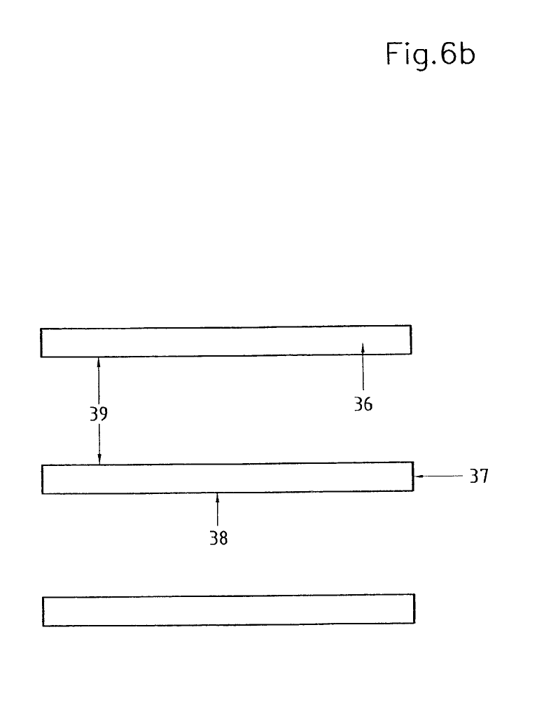

FIG. 6a illustrates the greatly enlarged top view of a laminate prior to the shrinkage treatment. The laminate is bonded over entire fabric width (34) by mutually parallel lines or bars of thickness (33), bar area (32) and bar spacing (35) using heat and pressure or by ultrasound. This embossing bonding is referred to as LS (linear seal) within the scope of the present specification.

The state illustrated in FIG. 6b results after a shrinkage of approximately 25% performed exclusively crosswise to the machine running direction (“MRD”). Thus, fabric width (34) illustrated in FIG. 6a is reduced by 25% to fabric width (38) illustrated in FIG. 6b. Because no shrinkage occurs in the MRD, the thickness of the bars remains unchanged, i.e., (33) corresponds to (37), and the distance between them also remains constant, i.e., (35) corresponds to (39).

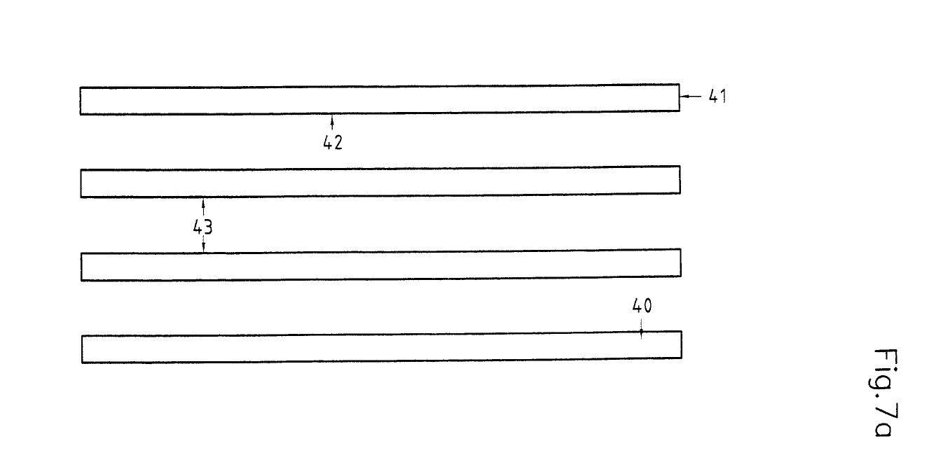

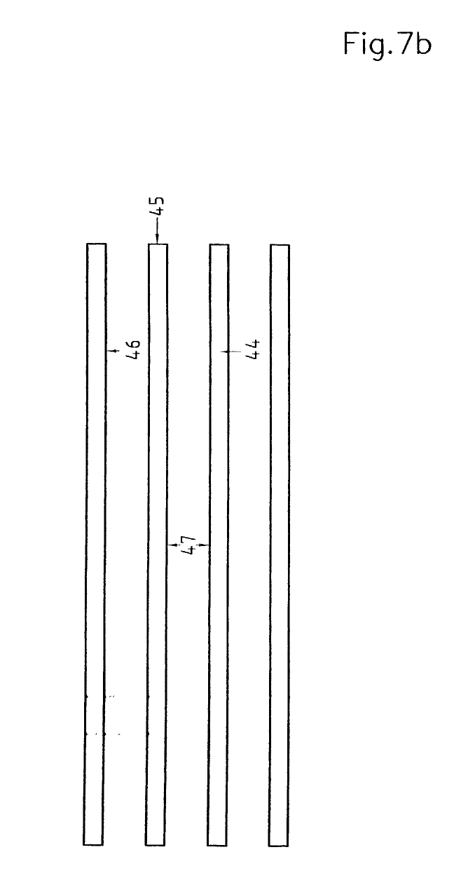

FIGS. 7a and 7b again illustrate the greatly enlarged top view of an LS-bonded laminate before and after shrinkage. In this case, a shrinkage of 23% has occurred exclusively in MRD (48). The fabric width remains unchanged accordingly (assuming that no distortions occur), and therefore the length of the bars as well, i.e., (42) corresponds to (46). Area (40) of the bars prior to shrinkage is reduced by 23% to area (44), as is distance (43) of the bars prior to shrinkage reduced by 23% to distance (47) after shrinkage, and accordingly, bar width (41) prior to shrinkage is reduced to bar widths (45) after shrinkage.

The 3-layer laminate having exclusively linear shrinkage in MRD, illustrated in a top view in FIG. 7b, yields a perspective view as illustrated in FIG. 1, with clearly formed undulations, height (11) of the undulations at their peak (3) along line (49) being constant over the entire fabric width.

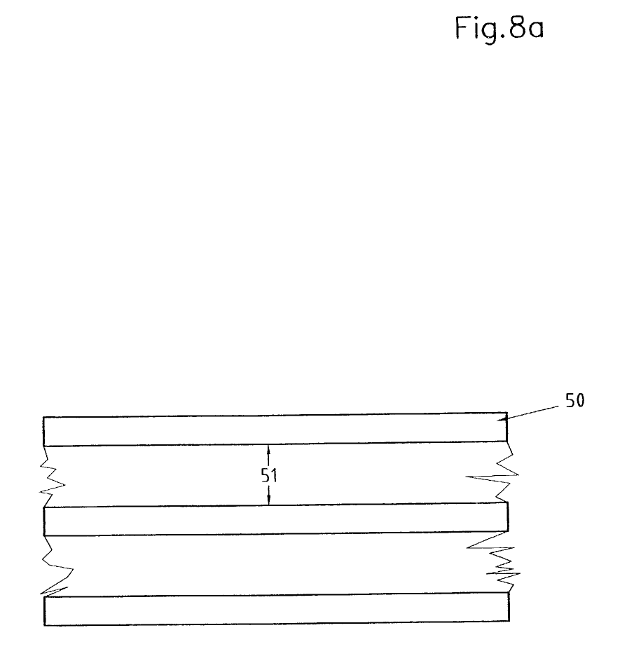

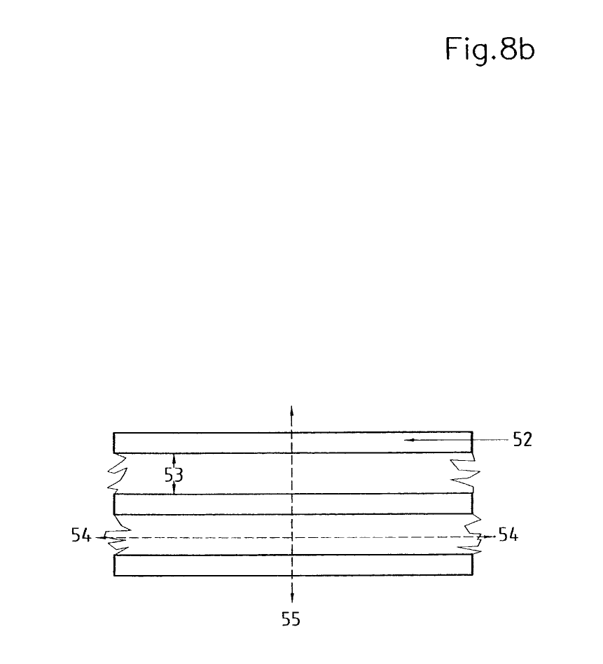

FIGS. 8a and 8b illustrate the case of shrinkage in a three-layer laminate such as, for example, a laminate of nonwoven fabric/shrink film/nonwoven fabric, i.e., both bar bonding area (52) and bar distance (53) are reduced in size in accordance with the shrinkage crosswise to the MRD and in the MRD to (54) and (55), respectively, after the shrinkage.

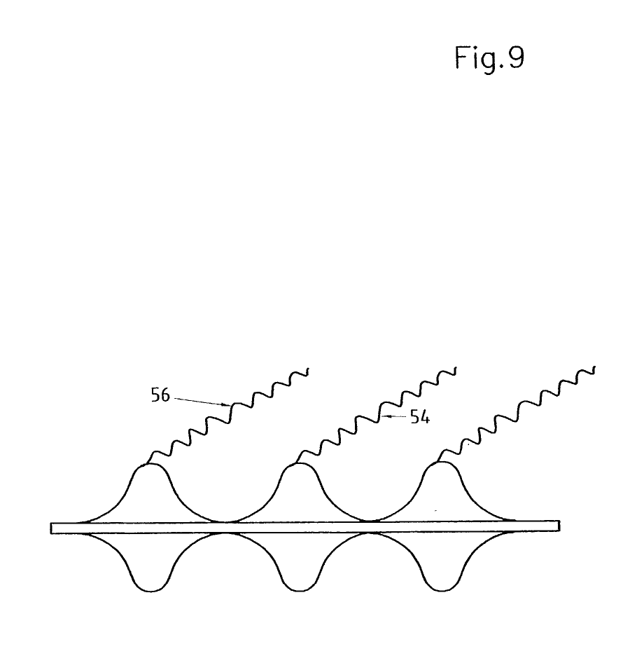

FIG. 9 is a perspective view of the laminate illustrated in FIG. 8b, the cross-section of the perspective view being illustrated along line 57, and the status being illustrated along line 56.

In this context, the height of the undulations along line 56 may not always be the same over the entire fabric width, but rather also includes a micro-undulation (58) caused by the crosswise shrinkage itself.

The following examples clarify the present invention without limiting it.

### EXAMPLE 1

To lay a fleece, a stripper with cross lapper (designated by K1), a stripper above the fiber lay-up band (designated by K2), with laying of the staple fibers in the machine running direction, and another stripper with cross lapper (designated by K3) were used. It was thereby possible to implement the desired three-layer composite structure of the nonwoven fabric. The fibrous-web layers laid using K1, K2 and K3 were denoted by F1, F2 and F3, respectively.

The fiber composition, the fiber orientation and the fibrous-web weights of F1 and F3 were identical. F1 and F2 were composed of 40% of a core/sheath fiber made from the two components polyethylene terephthalate as core and a co-polyester having a melting range of 91 - 140° C. with a titer of 17 dtex and a staple length of 64 mm, and 60% of a homofil fiber made of polyethylene terephthalate with a titer of 8.8 dtex and a staple length of 60 mm. F1 and F3 were laid crosswise to the machine running direction (designated by “cd” for cross machine direction). The fleece weight of F1 and F2 was in each case 10 g/m². K2 was laid between K1 and K3 in the machine running direction (designated by “md” for machine direction) and was made of a 10 g/m² heavy fleece of 100% polypropylene fibers having a titer of 12 dtex and a staple length of 60 mm.

All the fibers used in Example 1 were fully stretched. The crimping of the bicomponent fibers and of the polyethylene terephthalate fibers was two-dimensional and was performed according to the stuffer box or crimping device principle. The polypropylene fibers of fiber layer F2 exhibited a three-dimensional helical crimp. Such fibers may be used when the intention is to produce a high compression-resistance of the fiber layers and comparatively high volumes (so-called high-loft fibers).

The melting points of the polyethylene terephthalate fibers or of the polyethylene terephthalate fiber core of the heterofil fibers, with over 90° C., were so far apart, that in response to the heating of the composite nonwoven fabric to the shrinkage temperature of the polypropylene fibers, they exclusively experienced a shrinkage.

The three-layer composite, made up of the three fleeces F1, F2 and F3, was compacted slightly at 80° C. by passage through two steel pressing rollers that had been heated to a temperature of 80° C., before it was fed to the pair of calender rollers.

The calender roller pair was made of one smooth steel roller and one engraved steel roller. The engraved steel roller had mutually parallel, straight lines or strips oriented transversely to the machine running direction and having a width of 1.0 mm. The spacing of the parallel strips, measured in each case from center to center, was 4.0 mm. The heat-sealing area was 25%. The elevations of the strips were cone-shaped. The engraving depth was 0.9 mm.

Both rollers were heated to a temperature of 130° C. The pressing line pressure was 65 N/mm. Because of the symmetrical structure of the three-layer composite, i.e., because of the fact that F1 and F3 were identical, it did not make any difference which of the two had contact with the engraved roller while passing through the calender.

The material heat-sealed in this manner by heat and pressure was subjected in a tenter frame to a temperature of 160° C. over a time period of 30 seconds in a drying oven. Due to this thermal treatment, the fabric shrunk by 45.1% in the md and by 20.2% in the cd.

Despite the combing out of fiber layer F2 in the md, a slight shrinkage nevertheless also occurred in the cd because of the fiber crimping and its certain fiber crosswise orientation component associated with it. From the shrinkage amounts in the md and the cd, an area shrinkage of 56.7% was calculated. However, using the following listed mathematical equations (i), (ii) and (iii), the area shrinkage may also be calculated from the masses per unit area in g/m² of the composite nonwoven fabric before and after the shrinkage treatment, for the case that no contraction in area or loss in width has occurred due to distortions.

Sₒ=(1−Gᵥ/Gₙ) * 100 [%] (i)

S_{q}=(1−bₙ/bᵥ) * 100 [%j (ii)

S_{I}=(1−(Gᵥ * bᵥ)/(Gₙ * bₙ)) * 100 [%] (iii)

The meanings in these formulas are:

Sₒ=area shrinkage in %

S_{q}=linear shrinkage in crosswise direction in %

Sₗ=linear shrinkage in lengthwise direction in %

Gᵥ=mass per unit area prior to shrinkage in g/m²

Gₙ=mass per unit area after shrinkage in g/m²

bᵥ=fabric width prior to shrinkage in m

bₙ=fabric width after shrinkage in m

After shrinkage of the middle 100% polypropylene fiber layer F2 of the three-layer nonwoven-fabric composite, the undulations illustrated in FIG. 1, aligned on both sides into the third dimension, were formed. Despite the completely symmetrical structure of the composite of F1, F2 and F3, the peaks of the undulations were slightly higher on the side of the engraving roller than those that were facing the smooth steel roller during calendering.

These differences in the peak height on both sides of shrunk fiber layer F2 proved to be all the less, the higher the engraving depth was.

Table 1 lists the laminate structure and shrinkage ratios of Examples 1 through 5. The thickness given a surface pressure of 780 Pa, the mass per unit area, the resilience capacity after a defined compression load and the compression resistance were measured.

The compression resistance KW, the recovery capacity W and the creep stability KB may play an important role for use as an absorption and distribution layer in diapers. These relative quantities are each calculated from the thicknesses at two different compressive loads.

The thickness measurements were performed as follows:

The test specimen was loaded for 30 seconds with a surface pressure of 780 Pa (8 g/cm²) and a reading of the thickness was taken after these 30 seconds had expired. Immediately thereafter, the surface pressure was increased to 6240 Pa (64 g/cm²) by changing the weight on the thickness measuring device, and after a further 30 seconds, a reading of the thickness was made at the exact same measuring location. KW is calculated from the ratio of the thickness at 6240 Pa and the thickness at 780 Pa and is stated in percentage.

Subsequent to the aforesaid thickness measurement sequence, the thickness is again determined at 780 Pa at the exact same measuring location. The resilience capacity W is calculated from the ratio of the thickness at 780 Pa first measured and the thickness at 780 Pa after the concluded measurement sequence, and is likewise stated in percentage.

To determine the creep resistance KB, the test specimen was loaded or stressed for 24 hours at a pressure of 3500 Pa (36 g/cm²) and a temperature of 60° C., and the thickness was thereupon determined after a load of 780 Pa. The value for KB is obtained by dividing the thickness of the test specimen pressed at 60° C. over 24 hours at 3500 Pa, by the thickness of the unpressed test specimen, in each case measured at 780 Pa, and multiplying by 100 (statement in percentage).

In the case of Example 2, high values were reached for the resilience capacity and the compression resistance relative to the very favorable ratio of thickness in mm to the mass per unit area in g/m². This is a result of the undulations that are on both sides and are aligned in mirror image.

Requirements with high resilience capacity and compression resistance, paired with high pore volume and hydrophilic, good wetting properties with respect to bodily fluids, are conventional for liquid and distribution layers in diapers, the layers being inserted between the covering nonwoven fabric and the absorbent core for the purpose of improved fluid management. The pore volume is calculated from the thickness of the fabric (given a defined surface pressure=load), i.e., as the difference from the volume resulting therefrom and the volume which is occupied by the fibers themselves. The pore distribution and pore size are greatly influenced by the ratio of thickness to mass per unit area. The coarser the fibers and the greater the thickness of the fabric forming them, the larger the pores and the lower their number become. High pore volume and large pores are factors promoting the absorption of fluid.

Another example embodiment of the present invention explained in Example 1 may be suited for this use, and with regard to fluid management, may be superior to other product design approaches. To verify this, as comparison to Example 1, a thermally bonded nonwoven fabric having comparable mass per unit area and identical fiber blend F1 and F3 was utilized. The 3 layers from which the composite was made up were designated by S1, S2 and S3. In the case of Example 1, all three layers were made up of fibers (F1, F2 and F3).

The superiority of Example 1 according to the present invention is discernible from the values of Table 1 for Example 1 and the comparison example.

### EXAMPLE 2

In Example 2, the same web-laying methods were used as in Example 1, that is to say, the fibers of F1 or S1 were laid down in the cd, F2 or S2 in the md, and F3 or S3 again in the cd. The heat-sealing conditions in the calender, the engraving roller used and the shrinkage conditions were identical with Example 1. The lower shrinkage amount in comparison to Example 1 is probably a result of the higher fleece weights F1 and F3. As can be seen from Table 1, different fibrous-web weights and finer fiber titers were used.

Because of the finer fibers and the lower area shrinkage of 50.6%, it may be that, let us say, the same compression resistance and a comparable resilience capacity were achieved as with Example 1. This, however, at a perceptibly lower thickness of 2.70 mm instead of 3.60 mm. However, the results are nevertheless superior in the comparison to the related art. The measuring results are shown in Table 2.

### COMPARISON EXAMPLE FOR EXAMPLES 1 AND 2

In the machine running direction, a 70 g/m² fleece made of 50% core/sheath bicomponent fibers having polypropylene as core and high density polyethylene (HDPE) as sheath with a titer of 3.3 dtex and a staple length of 40 mm, and 50% polyethylene terephthalate fibers having a titer of 6.7 dtex and a staple length of 60 mm was thermally bonded in a circulating air oven at a temperature of 130° C.

The measuring results performed on this material were compiled in Table 2 and compared with those of Examples 1 and 2.

### EXAMPLE 3

For manufacturing the composite described in Example 3, two strippers were needed which laid down fiber layer F1, having a fleece weight of 25 g/m², in machine running direction (md), and a further stripper which laid down a fleece weight of 10 g/m² crosswise to the machine running direction (cd). A PP net, fully stretched exclusively in the md, having a mesh width in the md of 3.2 mm and in the cd of 7.7 mm and a mass per unit area of 30.0 g/m² was inserted between both fleeces. As in Example 1, after a hot pre-pressing for the purpose of compacting, the three layers, i.e., layers S1, S2 and S3, were fed to the calender nip made of the rollers already indicated in Example 1, the fibrous-web layer F1 with the higher weight of 25 g/m2 having faced the engraved calender roller. The calendering was performed at a line pressure of 65 N/mm and a temperature of 150° C.

The test specimen was subsequently left without distortion for 30 seconds in the drying oven with a temperature of 150° C. A shrinkage of 16% exclusively in the md ensued. Because of the net stretching only in the md, the shrinkage in the md completely failed to appear. In this manner, as illustrated simplified in FIG. 1, clearly defined undulations on both sides of the central layer of PP net S2 formed again in cross-section crosswise to the machine running direction. Because of its contact with the smooth roller during the calendering, the undulation height of fiber layer S3 was somewhat less, softer and less resilient because of its finer-titer fiber structure and the lower mass per unit area of only 8 g/m².

Such asymmetrically constructed composites having a soft, less lofty and light fine-fiber layer and a high-loft coarse-fiber layer may be used when completely different demands are placed on the two surfaces of the composite. Completely different properties on the two sides of a composite non-woven fabric are provided, for example, on a belt which—with or without elastic properties along the lengthwise direction of the belt—is intended to be used simultaneously in its entire surface or partial surface as an entanglement or mechanically sticking part (loop part) for the hook part of a mechanical fastening system (Velcro strip fasteners). Such opposite requirements, such as good entanglement properties (due to the undulating coarse-fiber layer) on one side, and textile qualities, softness and compatibility with the skin on the other side, paired with a certain stiffness (as belts) may be found in the best accord with the present invention.

### EXAMPLE 4

Example 4 differs from Example 3 only in that the two fibrous webs for layers S1 and S3 were not laid in the machine running direction, but rather crosswise to the machine running direction, a ratio of tensile strengths in md to cd of 0.8:1.0 having ensued on the calender-bonded half material.

Under the same calendering and shrinkage conditions, a shrinkage amount in the md of 25% and in the cd of likewise 0% was attained. This result is an indication that the shrinkage of the composite, both from the orientation of the stretched shrinkage medium and the orientation of the fibers of the fibrous web not shrinking under process conditions (or shrinking less than the shrinkage medium) exerts a marked influence on the shrinkage amount. The lower the fiber titer and the lower the fibrous-web weights of S1 and S3, and the nearer its fibers were aligned perpendicular to the shrinkage direction, i.e., in the case of Example 4, crosswise to the machine running direction, the less the shrinkage was hindered by the two outer fibrous webs of layers S1 and S3

### EXAMPLE 5

A 20 g/m² heavy fibrous web made of 30% by weight heterofil fibers having a core of polyethylene terephthalate and a sheath of high density polyethylene (HDPE), and 70% by weight polypropylene having a titer of 2.8 dtex and a staple length of 60 mm was laid on a 15 μm thick polyethylene film and fed to the pair of calender rollers described in Example 1. The calender temperature was 130° C. and the pressure was 65 kp. Shrinkage was subsequently performed again for 30 seconds in the oven at 150° C., after which a shrinkage in the md of 22% set in.

Because of the fact that a fibrous web was welded in a line shape on only one side of the shrink film, an undulation formed on only one side after the shrinkage process.

TABLE 1
Structure of the shrunk composite

Product Composite composition; S1, S2, S3

weight shrinkage % in mass per unit area

Variant = composition of layers 1, 2, 3 g/m² *⁾ md cd area
before shrinkage after shrinkage
Example 1 S1: 40% PET/Co-PES (?) dtex 17/64 mm 10
100% 60% PET dtex 8/60 mm
nonwoven S2 100% PP helical crimp dtex 12/60 mm 10 45.1 20.2

47.8 30 68.5

3-layer S3: 40% PET/Co-PES dtex 17/64 mm 10

60% PET dtex 8/60 mm

Example 2 S1: 50% PET/Co-PES dtex 4.8/55 mm 15
100% 50% PET dtex 6.7/90 mm
Nonwoven S2: 100% PP helical crimp Dtex 6.7/90 mm 10 39 19

50.6 40 81.0

3-layer S3: 50% PET/Co-PES dtex 4.8/55 mm 15

50% PET dtex 6.7/90 mm

Example 3 S1: 30% PET/PP dtex 3.3/51 mm 25
Fleece of 70% PET dtex 6.7/50 mm
S1 and S3 S2: in md monoaxial md 3.2 mm 30 16

0 16 65 77.4

in md stretched PP net cd 7.7 mm
oriented S3: 30% PET/PP dtex 3.3/51 mm 10

70% PET dtex 1.7/38 mm

Example 4 S1: 30% PET/PP dtex 3.3/51 mm 25
Fleece of 70% PET dtex 6.7/50 mm
S1 and S3 S2: in md monoaxial md 3.2 mm 30

25 0 25 6586.7

in cd stretched PP net cd 7.7 mm
oriented S3: 30% PET/PP dtex 3.3/51 mm 10

70% PET dtex 1.7/38 mm

Example 5 S1: 30% PET/PE dtex 3.0/50 mm 20

70% PP dtex 2.8/60 mm

S2: uniaxial in md thickness 14 22 0 22 34
44

stretched PE film 15 μm

S3: —
*⁾ prior to shrinkage

TABLE 2
Measuring results

| Product | | Thickness | resilience | Compression | Creep resistance (%) |
|---|---|---|---|---|---|
| variant | Weight | at 780 Pa | capacity (%) | resistance (%) | from g/m² mm |
| Example 1 | 68.5 | 3.60 | 93 | 73 | 57 |
| Example 2 | 81.0 | 2.70 | 91 | 72 | 55 |
| Comparison | 70.2 | 2.95 | 76 | 60 | 44 |
| example for | | | | | |
| 1 and 2 | | | | | |

What is claimed is:

1. A three-dimensionally structured fibrous fabric, comprising:
at least one nonwoven-fabric layer; and
a shrunk fabric bonded to the nonwoven-fabric layer by heat sealing at least perpendicular to a direction of greatest shrinkage of the shrunk fabric in the form of regularly arranged lines;
the structured fibrous fabric including elevations and depressions arranged regularly in alternation with respect to a surface plane.

2. The three-dimensionally structured fibrous fabric according to claim 1, wherein a bonding pattern for fixing the nonwoven fabric layer in position on the shrunk fabric is in the form of regularly arranged and uninterrupted lines.

3. The three-dimensionally structured fibrous fabric according to claim 1, wherein the heat sealing is effected at least one of by heat and calender pressure and by ultrasound.

4. The three-dimensionally structured fibrous fabric according to claim 1, wherein the shrunk fabric includes at least one of a woven fabric, a knit fabric, a net, an interlaid scrim, parallel-running monofilaments, staple-fiber yarns, multifilament yarns, a nonwoven fabric and a film.

5. The three-dimensionally structured fibrous fabric according to claim 4, wherein the shrunk fabric includes one of a nonwoven fabric and a film.

6. The three-dimensionally structured fibrous fabric according to claim 5, herein the shrunk fabric is derived from one of a uniaxially and a biaxially stretched film.

7. The three-dimensionally structured fibrous fabric according to claim 1, wherein the three-dimensionally structured fibrous fabric includes one shrunk fabric and at least one nonwoven fabric layer that is one of not shrunk and shrunk less under process conditions.

8. The three-dimensionally structured fibrous fabric according to claim 1, wherein the three-dimensionally structured fibrous fabric includes three layers, including a shrunk fabric covered on both sides by a nonwoven fabric layer that is one of not shrunk and shrunk less under process conditions, the covering nonwoven fabrics including one of identical and different masses per unit area.

9. The three-dimensionally structured fibrous fabric according to claim 1, wherein the nonwoven fabric layer includes a staple-fiber nonwoven fabric.

10. The three-dimensionally structured fibrous fabric according to claim 1, wherein the at least one nonwoven fabric layer has a mass per unit area of 6 to 70 g/m².

11. The three-dimensionally structured fibrous fabric according to claim 1, wherein a pattern of the heat sealing of the nonwoven fabric layer and the shrunk fabric is arranged in the form of one of uninterrupted lines and bars arranged regularly at least one of transversely to and in a machine running direction.

12. The three-dimensionally structured fibrous fabric according to claim 1, wherein a pattern of the heat sealing of the nonwoven fabric layer and the shrunk fabric is arranged in the form of lines arranged regularly on a surface of the nonwoven fabric in the form of hexagons.

13. A method for producing a three-dimensionally structured fibrous fabric, comprising the steps of:
combining at least one of at least one fibrous web and one nonwoven fabric with a shrinkable fabric;
heat sealing the at least one of the fibrous web and the nonwoven fabric to the shrinkable fabric in the form of a line pattern, the line pattern arranged at least perpendicular to a direction of the greatest shrinkage of the shrinkable fabric; and
heating a resulting laminate to a temperature that shrinkage of the shrinkable fabric is triggered, and elevations and depressions occurring regularly in alternation in relation to the surface plane are formed.

14. The method according to claim 13, wherein the heat sealing step is performed at least one of by heat and calender pressure and by ultrasound.

15. A method, comprising the step of:
using a three-dimensionally structured fibrous fabric including at least one nonwoven-fabric layer and a shrunk fabric bonded to the nonwoven-fabric layer by heat sealing at least perpendicular to a direction of greatest shrinkage of the shrunk fabric in the form of regularly arranged lines, the structured fibrous fabric including elevations and depressions arranged regularly in alternation with respect to a surface plane, one of for liquid filtration, for dust filtration, for particle filtration, as a high-volume absorption and distribution layer in a hygiene article, as a high-volume absorption and distribution layer in a diaper, as a high-volume absorption and distribution layer in a feminine hygiene article, as a mechanically sticking part for a hook-and-loop fastener.
